(19) United States
(12) Patent Application Publication
(10) Pub. No.: US 2015/0160755 A1
(43) Pub. Date: Jun. 11, 2015

(54) TOUCH PANEL AND METHOD FOR DETECTING TOUCH SPOTS OF THE TOUCH PANEL

(71) Applicant: TIANJIN FUNAYUANCHUANG TECHNOLOGY CO., LTD., Tianjin (CN)

(72) Inventors: CHUN-LUNG HUANG, New Taipei (TW); CHIEN-YUNG CHENG, New Taipei (TW); PO-SHENG SHIH, New Taipei (TW)

(73) Assignee: TIANJIN FUNAYUANCHUANG TECHNOLOGY CO.,LTD., Tianjin (CN)

(21) Appl. No.: 14/101,568

(22) Filed: Dec. 10, 2013

(51) Int. Cl. G06F 3/044

(52) U.S. Cl. CPC G06F 3/044

(57) ABSTRACT

A touch panel having an anisotropic conductive film is disclosed. A method for detecting a touch spot of the touch panel having the anisotropic conductive film is also disclosed. The method includes the following steps. At least two adjacent first driving electrodes are driven simultaneously to obtain a first signal. At least two adjacent second driving electrodes are driven simultaneously to obtain a second signal. Finally, the touch spot is determined according to the first signal and the second signal.

### BACKGROUND

1. Technical Field

The present disclosure relates to a touch panel and a method for detecting a touch spot of the touch panel, especially a touch panel having an anisotropic conductive film and a method for detecting a touch spot of the touch panel having the anisotropic conductive film.

2. Description of Related Art

Touch sensing technology is capable of providing a natural interface between an electronic system and a user, and has found widespread applications in various fields, such as mobile phones, automatic teller machines, game machines, medical devices, liquid crystal display devices, and computing devices.

Nowadays, there are different types of touch panels, such as capacitive touch panel having an anisotropic carbon nanotube film as a transparent conductive film. However, the resistance distribution of the anisotropic carbon nanotube film is not uniform so the capacitive touch panel having the anisotropic carbon nanotube film has a low coordinate resolution and the detecting precision for a touch spot is affected.

What is needed, therefore, is to provide a touch panel and a method for detecting a touch spot of the touch panel, which can overcome the above-described shortcomings.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of one embodiment of a touch panel.

FIG. 2 is a schematic view of one embodiment of driving at least two adjacent first driving electrodes of the touch panel.

FIG. 3 is a waveform chart of voltage-time curves of inputting pulse signals into the touch panel.

FIG. 4 is a schematic view of one embodiment of obtaining the first signal by capacitance-to-digital converter of the touch panel.

FIG. 5 is a schematic view of another embodiment of obtaining the first signal by capacitance-to-digital converter of the touch panel.

FIG. 6 is a schematic view of other embodiments of obtaining the first signal by capacitance-to-digital converter of the touch panel.

FIG. 7 is a schematic view of one embodiment of driving at least two adjacent second driving electrodes of the touch panel.

FIG. 8 shows a schematic view of one embodiment of two touch spot T_{A} and T_{B} moving from the first side to the second side along the first impedance direction L of the touch panel.

FIG. 9 shows first coordinate-signal intensity curves of the first coordinate Y of the two touch spot T_{A} and T_{B} obtained by FIG. 8.

FIG. 10 shows a schematic view of a prior art of two touch spot T_{A}′ and T_{B}′ moving from the first side to the second side along the first impedance direction L of the touch panel.

FIG. 11 shows first coordinate-signal intensity curves of the first coordinate Y of the two touch spot T_{A}′ and T_{B}′ obtained by FIG. 10.

FIG. 12 is a schematic view of one embodiment of driving at least two adjacent electrode pairs of the touch panel.

FIG. 13 shows a schematic view of one embodiment of a touch spot T moving from the first side to the second side along the first impedance direction of the touch panel.

FIG. 14 shows first coordinate-signal intensity curves of the first signal, the second signal, the third signal, and ABS(V_{A1}−V_{A2}) obtained in FIG. 13.

FIG. 15 is a flow chart of one embodiment of a method for detecting a first coordinate of a touch spot of the touch panel.

FIG. 16 is a schematic view of one embodiment of driving the electrode pairs successively of the touch panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

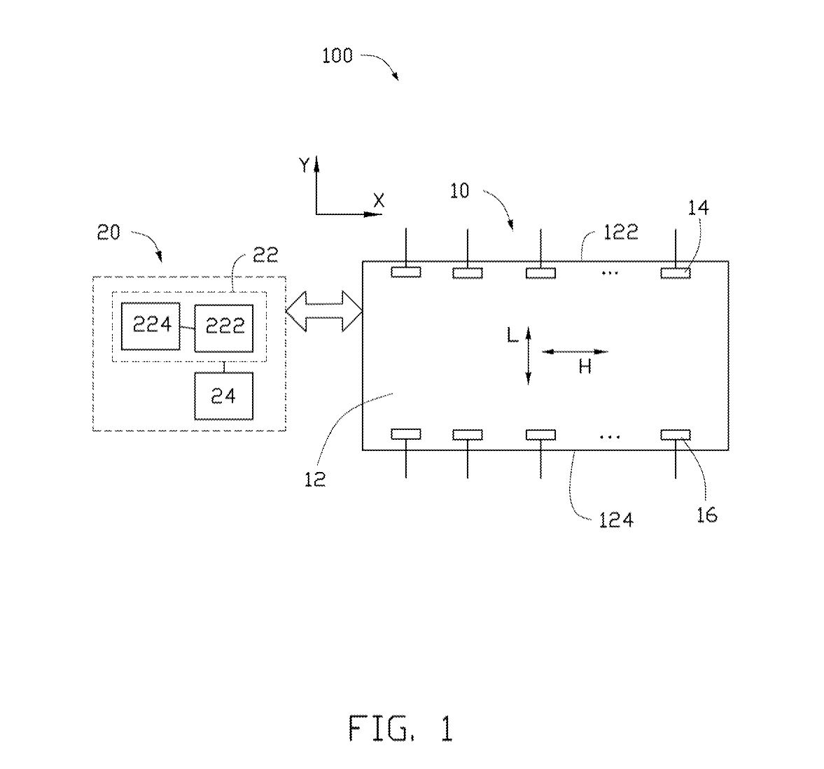

Referring to FIG. 1, according to one embodiment, a touch panel 100 includes an electrode layer 10 and a driving device 20 electrically connected with the electrode layer 10.

The electrode layer 10 includes a transparent conductive film 12 with an anisotropic impedance, a number of first driving electrodes 14, and a number of second driving electrodes 16. The electrode layer 10 can be located on a surface of the substrate (not shown). The transparent conductive film 12 defines a first impedance direction L and a second impedance direction H substantially perpendicular to the first impedance direction L due to the anisotropic impedance. Furthermore, the transparent conductive film 12 includes a first side 122 and a second side 124 opposite to the first side 122. The first side 122 and the second side 124 are substantially parallel to the second impedance direction H. The first driving electrodes 14 are disposed at the first side 122 of the transparent conductive film 12 with a regular interval and electrically connected to the transparent conductive film 12. Similarly, the second driving electrodes 16 are disposed at the second side 124 of the transparent conductive film 12 with a regular interval and electrically connected to the transparent conductive film 12. The first impedance direction L can be substantially parallel to a Y axis shown in FIG. 1. The second impedance direction H can be substantially parallel to an X axis shown in FIG. 1. Each first driving electrode 14 is aligned with each second driving electrode 16 in one to one manner to form a number of electrode pairs.

The transparent conductive film 12 can be formed by a drawn carbon nanotube film which can be pulled/drawn from a carbon nanotube array. The carbon nanotube array can be formed on a silicon substrate by chemical vapor deposition. The drawn carbon nanotube film includes a number of successive and aligned carbon nanotubes joined end-to-end by van der Waals force therebetween. The drawn carbon nanotube film is a freestanding film, meaning that the drawn carbon nanotube film does not need to be supported by a substrate and can sustain the weight of itself when it is hoisted by a portion thereof without tearing. The drawn carbon nanotube film has a minimum impedance along the direction of the aligned carbon nanotubes and a maximum impedance along the direction substantially perpendicular to the aligned carbon nanotubes so as to have the anisotropic impedance of the drawn carbon nanotube film. The maximum impedance of the drawn carbon nanotube film is about 50 times to 350 times larger than the minimum impedance of the drawn carbon nanotube film. In one embodiment, the first impedance direction L is substantially the direction of the aligned carbon nanotubes. The second impedance direction H is the direction substantially perpendicular to the direction of the aligned carbon nanotubes. When a conductive subject (not shown) is near or touches the touch panel 100, the touch spot T of the touch panel 100 and the conductive subject form a coupled capacitance with a capacitance value.

The driving device 20 is electrically connected with the electrode layer 10. The driving device 20 includes a control unit 22 and a sensing unit 24. The control unit 22 is electrically connected with the electrode layer 10. The control unit 22 is capable of driving the electrode layer 10. During the driving process, the coupled capacitance is charged and then discharged by at least two adjacent first driving electrodes 14, at least two second adjacent driving electrodes 16, or at least two adjacent electrode pairs at the same time. In one embodiment, the control unit 22 includes a driving unit 222 and a process unit 224. The process unit 224 is used to control the driving unit 222. The driving unit 222 is used to charge and then discharge the coupled capacitance. The sensing unit 24 is electrically connected with the electrode layer 10. The sensing unit 24 is capable of sensing electrical signal intensities of the coupled capacitance by at least two adjacent first driving electrodes 14, at least two second adjacent driving electrodes 16, or at least two adjacent electrode pairs at the same time, during the discharging process of the coupled capacitance. The electrical signal intensities of the coupled capacitance can be transformed to a number of numerical values by the sensing unit 24. The electrical signal intensities of the coupled capacitance can be voltage intensities or electrical quantity intensities. A coordinate of the touch spot T can be obtained from the numerical values. In one embodiment, the sensing unit 24 includes at least one capacitance-to-digital converter. The at least one capacitance-to-digital converter is used to sense the electrical signal intensities of the coupled capacitance, and then transform the electrical signal intensities to the numerical values.

Each of the driving device 20, the control unit 22, and the control unit 22 can be an integrated circuit, such as a microcontroller, a microprocessor, a digital signal processor, an application specific integrated circuit, a field programmable gate array or a logic circuit.

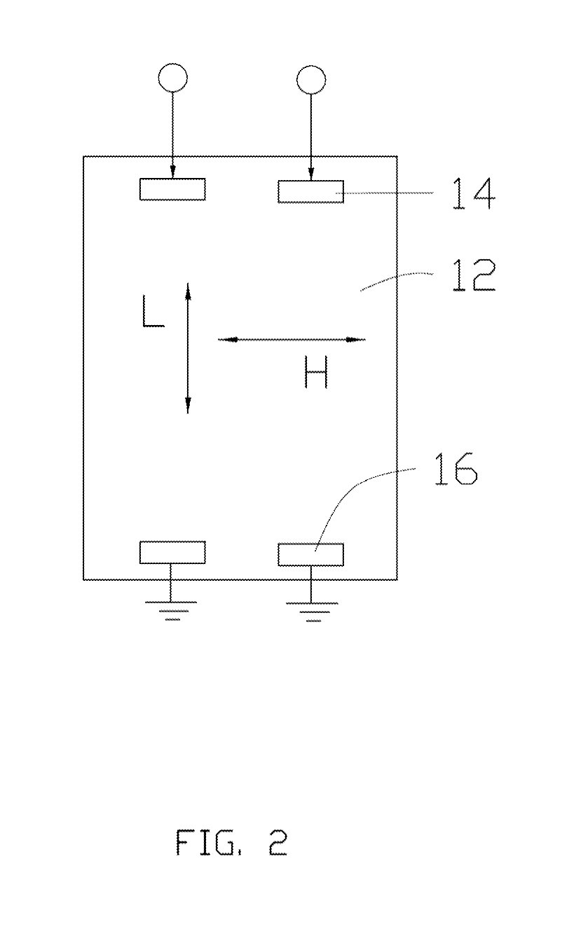

Referring to FIG. 2, one embodiment of a method for detecting a touch spot T of the touch panel 100 includes:

S1, simultaneously driving at least two adjacent first driving electrodes 14 to obtain a first signal V_{A1};

S2, simultaneously driving at least two adjacent second driving electrodes 16 to obtain a second signal V_{A2}, and obtaining a first coordinate Y of the touch spot T according to the first signal V_{A1}, the second signal V_{A2}.

Step S1 comprises sub-steps of:

S12: simultaneously applying a voltage to the at least two adjacent first driving electrodes 14; and

S14: obtaining the first signal V_{A1} by a first electrical signal intensity of the coupled capacitance obtained by simultaneously sensing the at least two adjacent first driving electrodes 14.

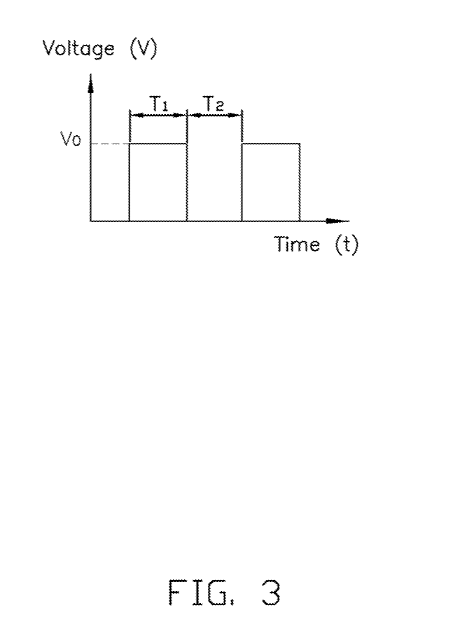

In step S12, the coupled capacitance is charged by the at least two adjacent first driving electrodes 14. When the voltage is applied to the at least two adjacent first driving electrodes 14 simultaneously, the second driving electrodes 16 and the other first driving electrodes 14 without the voltage applied thereon can be connected to Vₛₛ, V_{dd}, or floating. Referring to FIG. 2, in one embodiment, when the voltage is applied to the at least two adjacent first driving electrodes 14 simultaneously, the second driving electrodes 16 are connected to V_{dd}. Referring to FIG. 3, V₀ represents the voltage value applied to the at least two adjacent first driving electrodes 14. During a first period T₁, a voltage value V₀ is applied to the at least two adjacent first driving electrodes 14 simultaneously to charge the coupled capacitance. During a second period T₂, the coupled capacitance discharges.

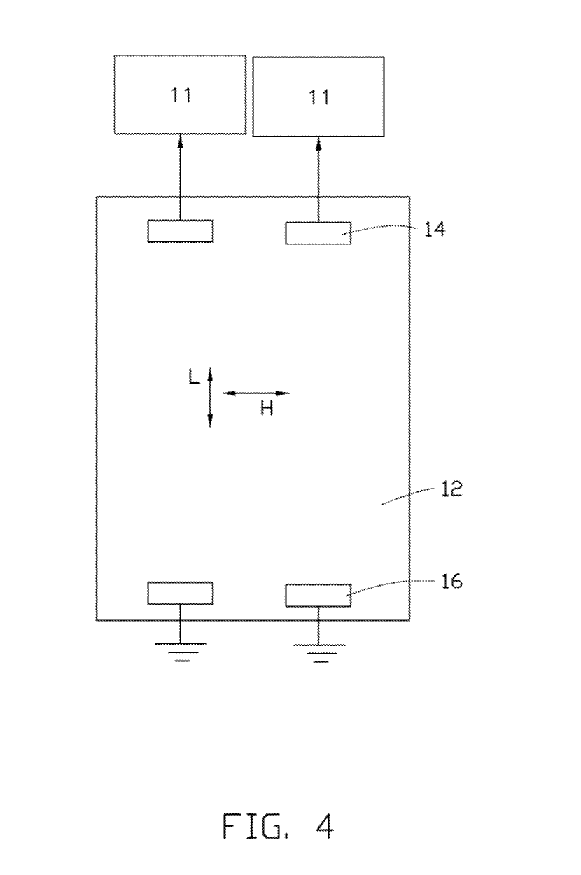

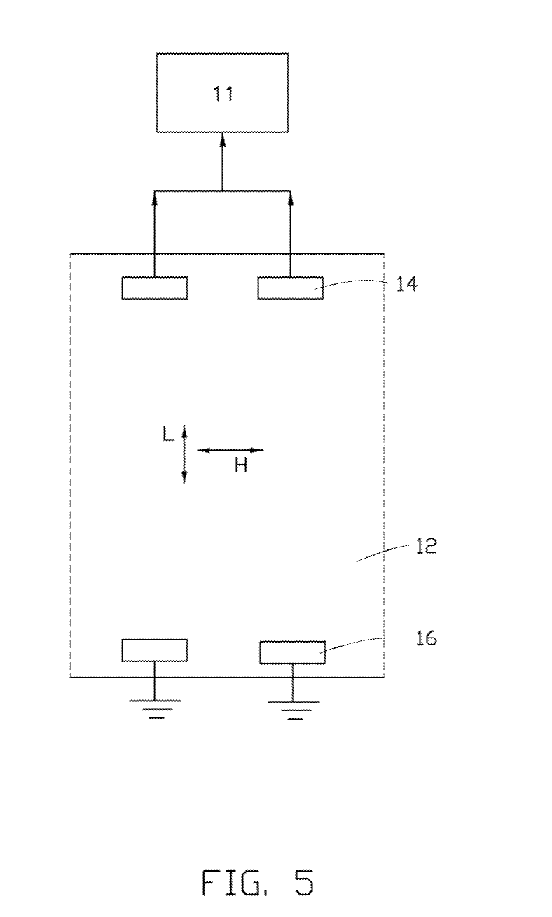

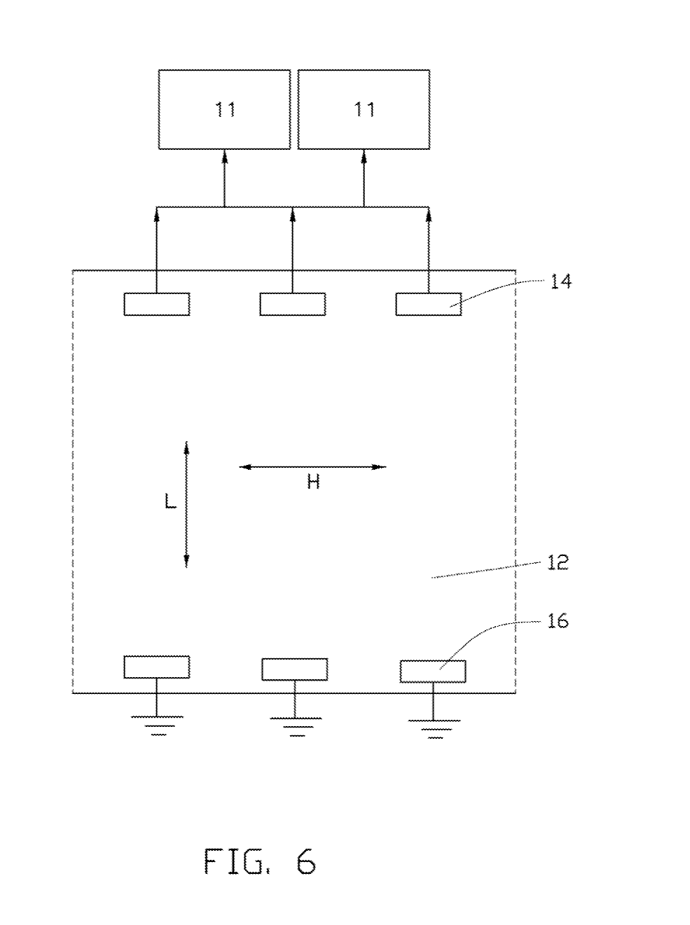

In step S14, the coupled capacitance discharges. The first electrical signal intensity can be obtained and be transformed to the first signal V_{A1} by at least one capacitance-to-digital converter 11. Referring to FIG. 4, in one embodiment, each of the at least two adjacent first driving electrodes 14 is electrically connected to each capacitance-to-digital converter 11, thus the first signal V_{A1} is a sum of the numerical values of all the capacitance-to-digital converters 11. Referring to FIG. 5, in another embodiment, the at least two adjacent first driving electrodes 14 are electrically connected to a single capacitance-to-digital converter 11 together, thus the first signal V_{A1} is obtained by the single capacitance-to-digital converter 11 directly. Referring to FIG. 6, in some other embodiments, adjacent two of the at least two adjacent first driving electrodes 14 are electrically connected to a capacitance-to-digital converter 11, thus the first signal V_{A1} is a sum of the numerical values of all the capacitance-to-digital converters 11.

Step S2 comprises sub-steps of:

S22: simultaneously applying a voltage to the at least two adjacent second driving electrodes 16;

S24: obtaining the second signal V_{A2} by a second electrical signal intensity of the coupled capacitance obtained by simultaneously sensing the at least two adjacent second driving electrodes 16; and

S26: obtaining a first coordinate Y of the touch spot T according to the first signal V_{A1} and the second signal V_{A2}.

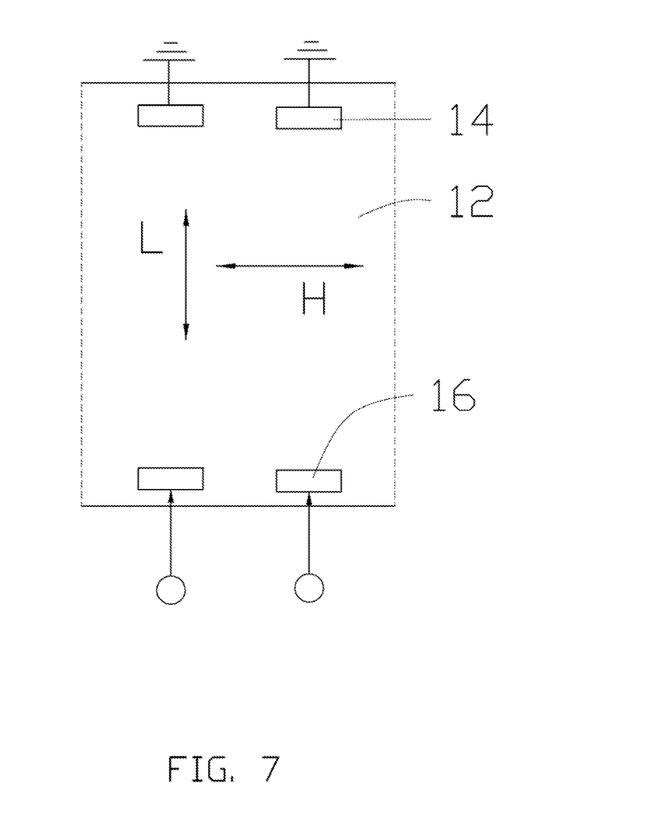

Steps S22 and S24 are similar to Steps S12 and S14 respectively, the difference is that when the voltage is applied to the at least two adjacent second driving electrodes 16 simultaneously, the first driving electrodes 14 and the other second driving electrodes 16 without the voltage applied thereon are connected to Vₛₛ, V_{dd}, or floating. Referring to FIG. 7, in one embodiment, when the voltage is applied to the at least two adjacent second driving electrodes 16 simultaneously, the first driving electrodes 14 are connected to V_{dd}.

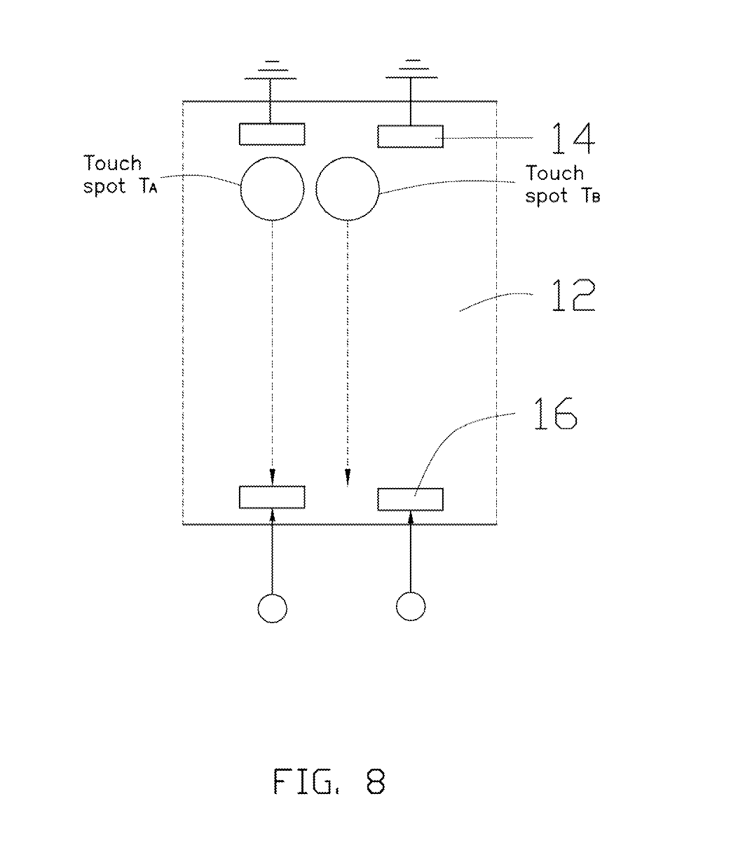

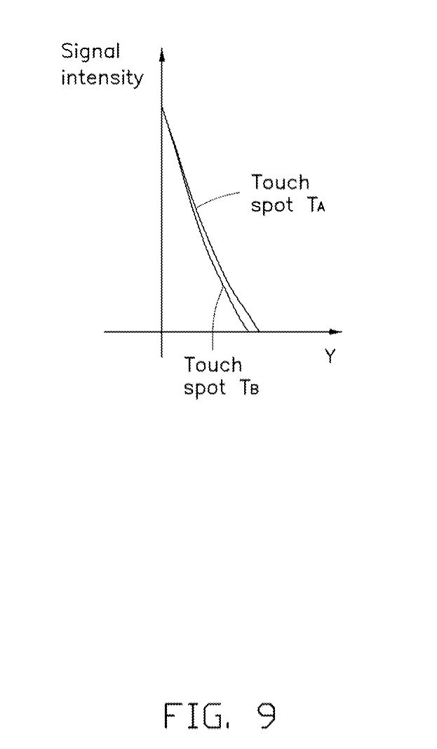

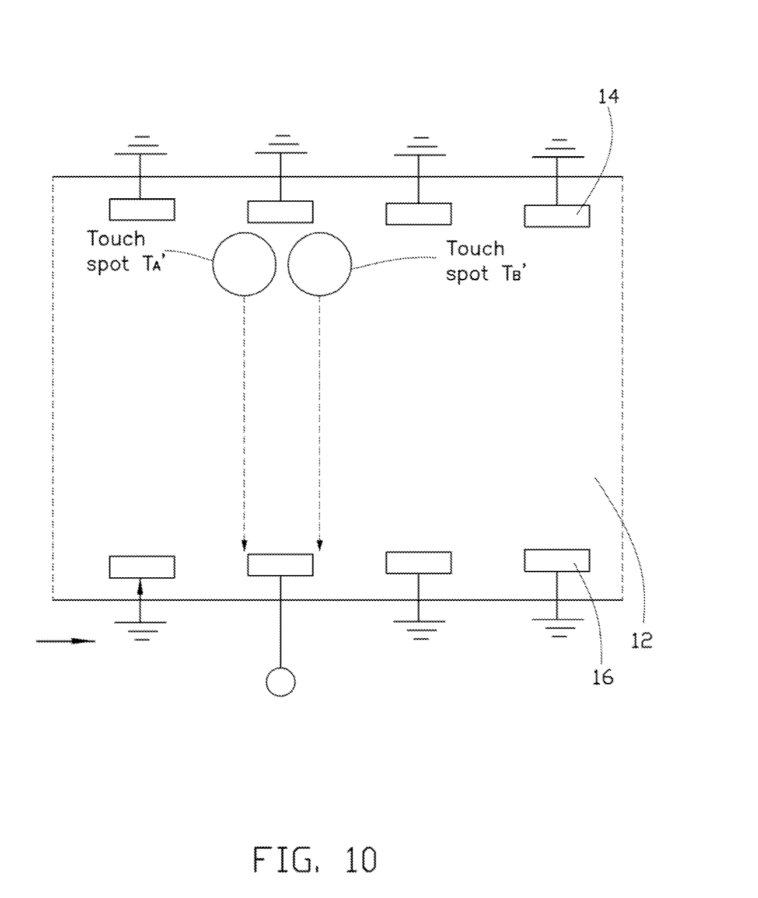

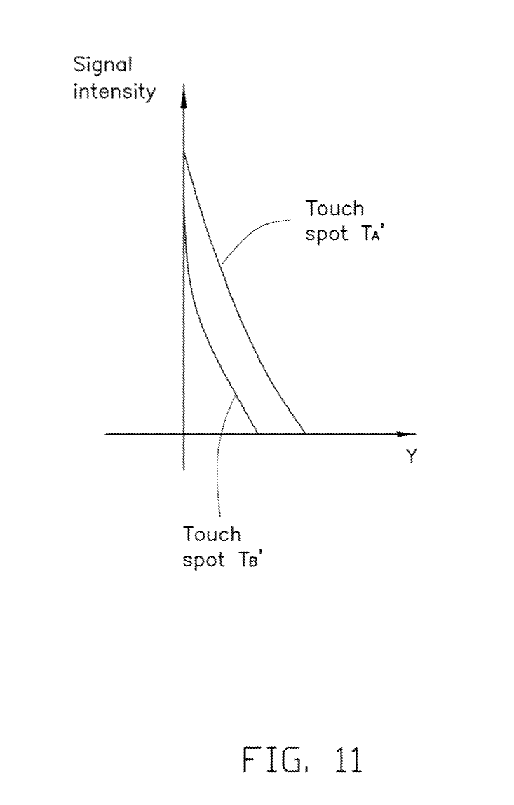

In step S26, referring to FIGS. 8 and 9, FIG. 8 shows two touch spots T_{A} and T_{B} moving from the first side 122 to the second side 124 along the first impedance direction L and driving the first driving electrodes 14 and the second driving electrodes 16 by the above method. FIG. 9 shows first coordinate-signal intensity curves of the first coordinate Y of the two touch spots T_{A} and T_{B}. Referring to FIGS. 10 and 11, FIG. 10 shows two touch spots T_{A}′ and T_{B}′ moving from the first side 122 to the second side 124 along the first impedance direction L and driving the first driving electrodes 14 and the second driving electrodes 16 one by one according to a comparative example. FIG. 11 shows first coordinate-signal intensity curves of the first coordinate Y of the two touch spot T_{A}′ and T_{B}′. It is obvious that the first coordinate Y of the touch spot T_{A} and the first coordinate Y of T_{B} are closer to each other. That is to say, the first coordinate Y of the touch spots can be precisely obtained.

The method for detecting the touch spot T of the touch panel 100 can further includes a step of:

S3, simultaneously driving at least two adjacent electrode pairs to obtain a third signal V_{A3}.

Step S3 comprises sub-steps of:

S32: simultaneously applying a voltage to the at least two adjacent electrode pairs; and

S34: obtaining the third signal V_{A3} by a third electrical signal intensity of the coupled capacitance obtained by simultaneously sensing the at least two adjacent electrode pairs.

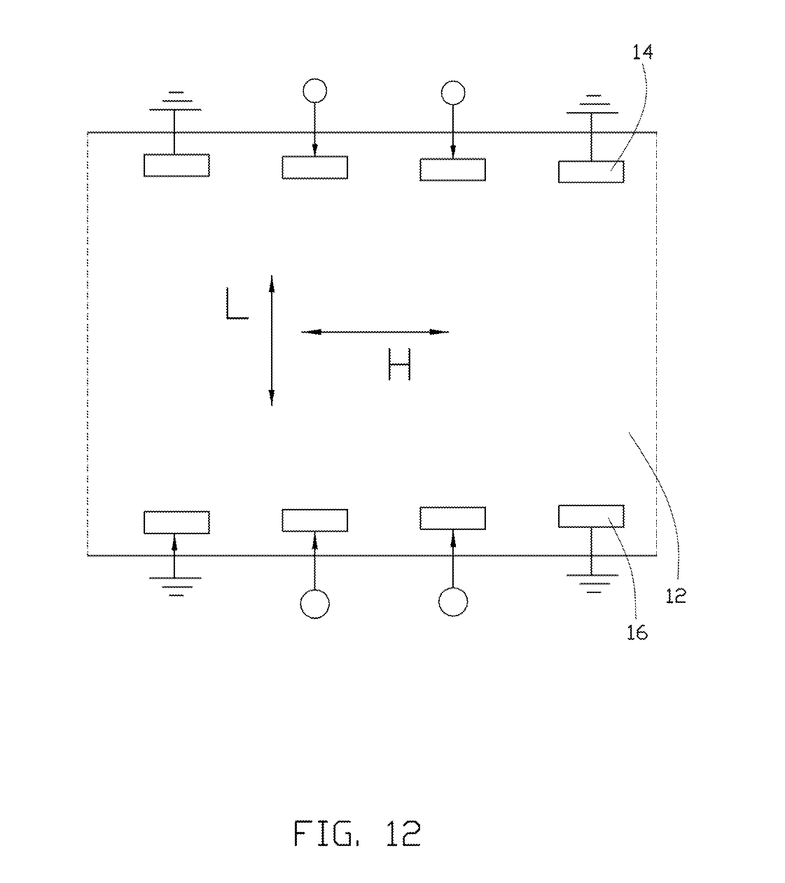

Steps S32 and S34 are similar to Steps S12 and S14 respectively, the difference is that when the voltage is applied to the at least two adjacent electrode pairs simultaneously, the other electrode pairs without the voltage applied thereon is connected to Vₛₛ, V_{dd}, or floating. Referring to FIG. 12, in one embodiment, when the voltage is applied to the at least two adjacent electrode pairs simultaneously, the other electrode pairs are connected to V_{dd}.

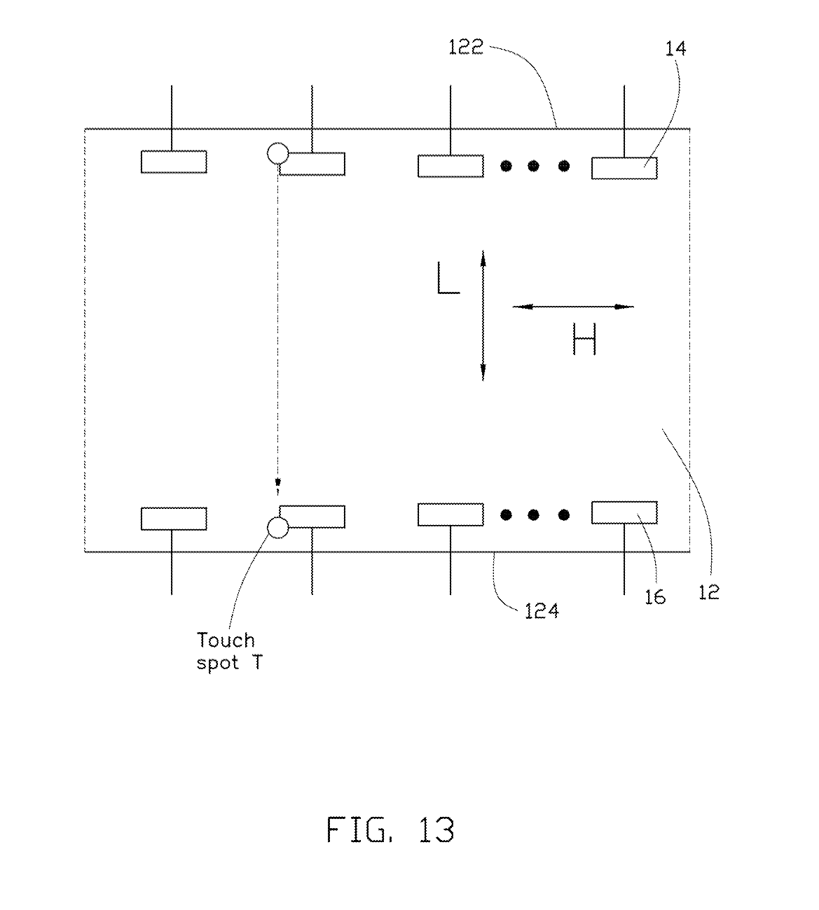

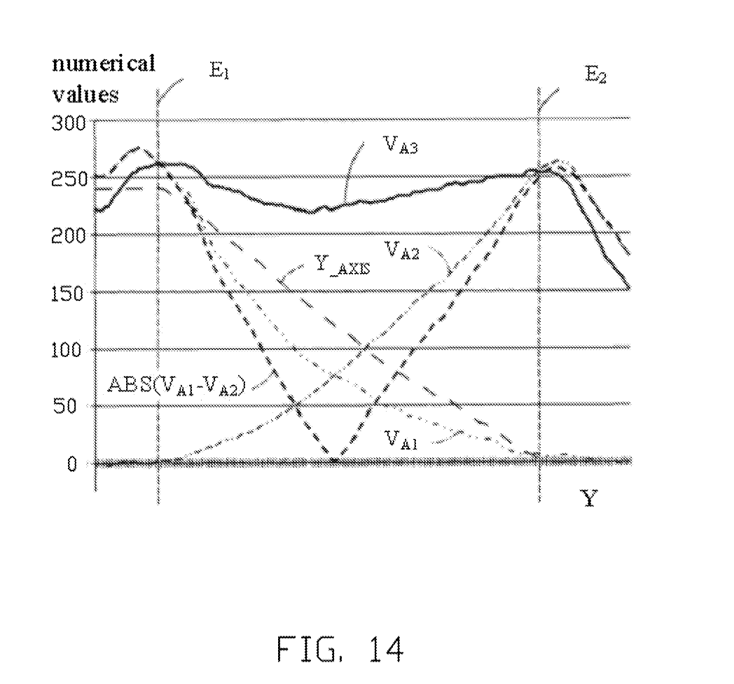

Referring to FIGS. 13 and 14, FIG. 13 shows the touch spot T moves from the first side 122 to the second side 124 along the first impedance direction L, and FIG. 14 shows first coordinate-signal intensity curves of the first signal V_{A1}, the second signal V_{A2}, the third signal V_{A3}, and ABS(V_{A1}−V_{A2}) according to the moving of the touch spot T, here, ABS represents an absolute value, E₁ represents the first side 122, and E₂ represents the second side 124. The curve of the ABS(V_{A1}−V_{A2}) satisfies a near linear relationship. Thus, the first coordinate Y of the touch spots T can be precisely obtained according to the curve of ABS(V_{A1}−V_{A2}).

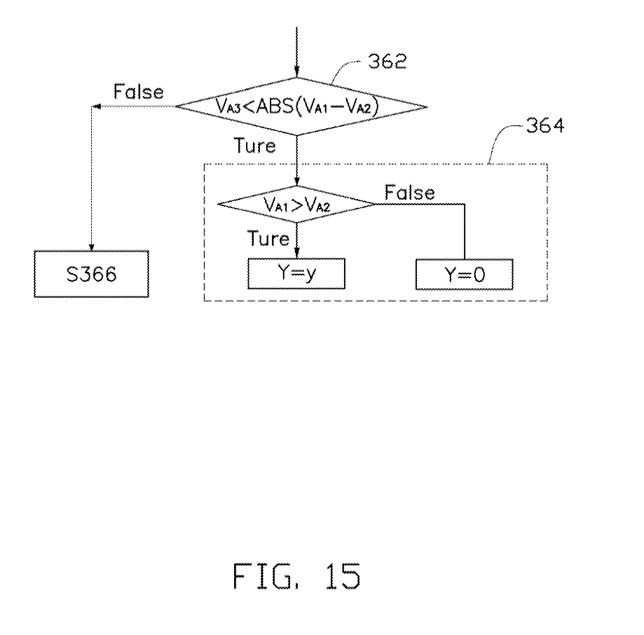

Referring to FIG. 15, the first coordinate Y of the touch point T can be more precisely obtained by the sub-steps of:

S362: if V_{A3}<ABS(V_{A1}−V_{A2}), determining the first coordinate Y by step S364; if V_{A3}≧ABS(V_{A1}−V_{A2}), determining the first coordinate Y by step S366;

S364: if V_{A1}>V_{A2}, determining the first coordinate Y=y; if V_{A1}<V_{A2}, determining the first coordinate Y=0, y represents a distance from the first driving electrodes 14 to the second driving electrode 16 along the first impedance direction L; and

S366: determining the first coordinate Y by one of the following formulas:

Y=(V_{A1}−V_{A2})/V_{A3}; 1)

Y=(V_{A2}−V_{A1})/V_{A3}; 2)

Y=(V_{A3}−(V_{A1}−V_{A2}))/V_{A3}=1−(V_{A1}−V_{A2})/V_{A3}; 3)

Y=½Y_{—res}×(V_{A3}−(V_{A1}−V_{A2}))/V_{A3}, 4)

Y_{—res} represents a solution of the first coordinate Y, and Y_{—res} can be 480, 600 or other integers; and

Y=½Y_{—res}×(V_{A3}′−(V_{A1}−V_{A2}))/V_{A3}′, and, V_{A3}′=V_{A3}+V_{A4}+V_{A5}. 5)

A second coordinate X of the touch spot T can be obtained by the following step:

S4, successively driving the electrode pairs to obtain a forth signal V_{A4} and a fifth signal V_{A5}, and obtaining the second coordinate X of the touch spot T according to the forth signal V_{A4}, the fifth signal V_{A5} and the third signal V_{A3}.

Step S4 comprises sub-steps of:

S42: applying a voltage to the electrode pairs successively;

S44: obtaining the fourth signal V_{A4} and the fifth signal V_{A5} by a fourth electrical signal intensity and a fifth electrical signal intensity of the coupled capacitance obtained by successively sensing the electrode pairs; and

S46: obtaining the second coordinate X of the touch spot T according to the fourth signal V_{A4}, the fifth signal V_{A5} and the third signal V_{A3}.

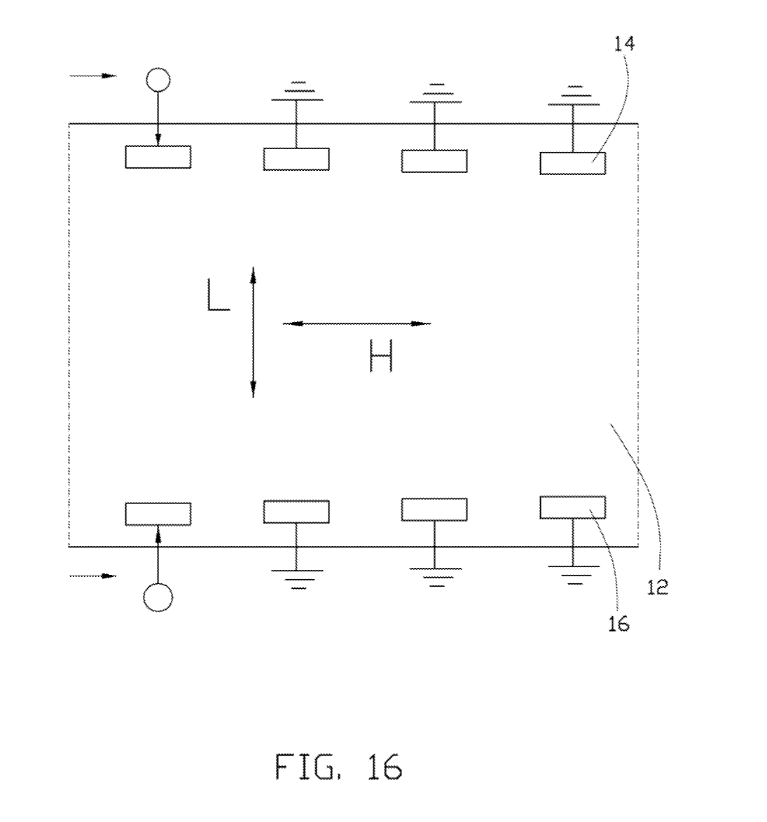

In step S42, the voltage is applied to the electrode pairs one by one. When the voltage is applied to one electrode pair, the other electrode pairs without the voltage applied thereon are connected to Vₛₛ, V_{dd}, or floating. Referring to FIG. 16, in one embodiment, when the voltage is applied to one electrode pair, the other electrode pairs are connected to V_{dd}.

In step S44, the fourth signal V_{A4} and the fifth signal V_{A5} can also be obtained by at least one capacitance-to-digital converter 11.

In step S46, the second coordinate X can be determined by one of following formulas:

X=(V_{A3}−(V_{A4}−V_{A5}))/V_{A3}; 6)

X=½X_{—zone}_{_{—}}ᵣₑₛ×(V_{A3}−(V_{A4}−V_{A5}))/V_{A3} and, X_{—zone}_{_{—}}ᵣₑₛ=Xᵣₑₛ/(P+1), 7)

here, X_{—res} represents a solution of the second coordinate X, P represents the number of the electrode pairs and Y_{—res} can be 1024, 800 or other integers; and

X=½X_{—zone}_{_{—}}ᵣₑₛ×(V_{A3}″−(V_{A4}−V_{A5}))/V_{A3}″, and, V_{A3}″=V_{A3}+V_{A1}+V_{A2}. 8)

Accordingly, the present disclosure is capable of providing a method for detecting a touch spot of a touch panel, which can improve the precision of detecting the touch spots. Furthermore, touch spots at the first side or the second side of the transparent conductive film can be precisely detected by the above method.

Finally, it is to be understood that the above-described embodiments are intended to illustrate rather than limit the present disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for detecting a touch spot of a touch panel, the touch panel comprising a conductive film and a plurality of electrode pairs, the conductive film defining a first impedance direction and a second impedance direction substantially perpendicular to the first impedance direction, the plurality of electrode pairs being arranged along the first impedance direction, each of the plurality of electrode pairs comprising a first driving electrode and a second driving electrode separately located on two opposite sides of the conductive film, the method comprising:
simultaneously driving at least two adjacent first driving electrodes to obtain a first signal V_{A1};
simultaneously driving at least two adjacent second driving electrodes to obtain a second signal V_{A2}, and obtaining a first coordinate Y of the touch spot T according to the first signal V_{A1} and the second signal V_{A2}.

2. The method as claimed in claim 1, wherein the simultaneously driving at least two adjacent first driving electrodes to obtain the first signal V_{A1} comprises the sub-steps of:
simultaneously applying a voltage to the at least two adjacent first driving electrodes simultaneously; and
obtaining the first signal V_{A1} by a first electrical signal intensity of a coupled capacitance obtained by simultaneously sensing the at least two adjacent first driving electrodes;
wherein the coupled capacitance is formed by the touch panel and a conductive subject, when the conductive subject is near or touches the touch panel.

3. The method as claimed in claim 2, the simultaneously driving at least two adjacent second driving electrodes to obtain the second signal V_{A2} comprises the sub-steps of:
simultaneously applying a voltage to the at least two adjacent second driving electrodes; and
obtaining the second signal V_{A2} by a second electrical signal intensity of the coupled capacitance obtained by simultaneously sensing the at least two adjacent second driving electrodes.

4. The method as claimed in claim 1, wherein the first electrical signal intensity and the second electrical signal intensity of the coupled capacitance are obtained by at least one capacitance-to-digital converter.

5. The method as claimed in claim 1, further comprising:
simultaneously driving at least two adjacent electrode pairs to obtain a third signal V_{A3}.

6. The method as claimed in claim 5, wherein the first coordinate Y of the touch spot is determined by the sub-steps of:
determining the first coordinate Y=y, when V_{A3}<ABS(V_{A1}−V_{A2}) and V_{A1}>V_{A2}, here, ABS represents an absolute value;
determining the first coordinate Y=0, when V_{A3}<ABS(V_{A1}−V_{A2}) and V_{A1}<V_{A2}; and
determining a second coordinate by a formula, when V_{A3}≧ABS(V_{A1}−V_{A2}).

7. The method as claimed in claim 6, wherein the first coordinate Y is determined by a formula of Y=(V_{A1}−V_{A2})/V_{A3}.

8. The method as claimed in claim 6, wherein the first coordinate Y is determined by a formula of Y=(V_{A2}−V_{A1})/V_{A3}.

9. The method as claimed in claim 6, wherein the first coordinate Y is determined by a formula of Y=(V_{A3}−(V_{A1}−V_{A2}))/V_{A3}.

10. The method as claimed in claim 6, wherein the first coordinate Y is determined by a formula of Y=½Y_{—res}×(V_{A3}−(V_{A1}−V_{A2}))/V_{A3}, here, Y_{—res} represents a solution of the first coordinate Y.

11. The method as claimed in claim 6, wherein the first coordinate Y is determined by a formula of Y=½Y_{—res}×(V_{A3}′−(V_{A1}−V_{A2}))/V_{A3}′, here, Y_{—res} represents a solution of the first coordinate Y, and, V_{A3}′=V_{A3}+V_{A4}+V_{A5}.

12. The method as claimed in claim 6, further comprising:
successively driving the electrode pairs to obtain a fourth signal V_{A4} and a fifth signal V_{A5}, and obtaining a second coordinate X of the touch spot T according to the forth signal V_{A4}, the fifth signal V_{A5} and the third signal V_{A3}.

13. The method as claimed in claim 12, wherein the second coordinate X is determined by a formula of X=(V_{A3}−(V_{A4}−V_{A5}))/V_{A3}.

14. The method as claimed in claim 12, wherein the second coordinate X is determined by a formula of X=½X_{—zone}_{_{—}}ᵣₑₛ×(V_{A3}−(V_{A4}−V_{A5}))/V_{A3}, here, X_{—zone}_{_{—}}ᵣₑₛ=Xᵣₑₛ/(P+1), X_{—res} represents a solution of the second coordinate X, P represents the number of the electrode pairs.

15. The method as claimed in claim 12, wherein the second coordinate X is determined by a formula of X=½X_{—zone}_{_{—}}ᵣₑₛ×(V_{A3}″−(V_{A4}−V_{A5}))/V_{A3}″, here, X_{—zone}_{_{—}}ᵣₑₛ=Xᵣₑₛ/(P+1), V_{A3}″=V_{A3}+V_{A1}+V_{A2}, X_{—res} represents a solution of the second coordinate X, P represents the number of the electrode pairs.

16. A touch panel comprising:
a conductive film defining a first impedance direction and a second impedance direction substantially perpendicular to the first impedance direction, the conductive film has a first side and a second side opposite to the first side, the first side and the second side are substantially parallel to the second impedance direction;
a plurality of first driving electrodes located at the first side;
a plurality of second driving electrodes located at the second side;
a driving device electrically connected with the transparent conductive film by the plurality of first driving electrodes and the plurality of second driving electrodes;
a control unit capable of charging and then discharging a coupled capacitance by at least two adjacent first driving electrodes, at least two second adjacent driving electrodes, or at least two adjacent electrode pairs at the same time, wherein coupled capacitance is formed by the touch panel and a conductive subject, when the conductive subject is near or touches the touch panel; and
a sensing unit is capable of sensing electrical signal intensities of the coupled capacitance during the discharging of the coupled capacitance.

17. The touch panel as claimed in claim 16, wherein the sensing unit comprises at least one capacitance-to-digital converter capable of sensing the electrical signal intensities of the coupled capacitance, and then transform the electrical signal intensities to numerical values.

18. The touch panel as claimed in claim 16, wherein the conductive film comprises a carbon nanotube film comprising a plurality of successive and oriented carbon nanotubes joined end-to-end by van der Waals force therebetween.

19. The touch panel as claimed in claim 16, wherein the impedance of the conductive film along the second impedance direction is about 50 times to 350 times larger than the impedance of the conductive film along the first impedance direction.
